(19) United States
(12) Patent Application Publication
(10) Pub. No.: US 2010/0011441 A1
(43) Pub. Date: Jan. 14, 2010

(54) SYSTEM FOR MALWARE NORMALIZATION AND DETECTION

(76) Inventors: Mihai Christodorescu, Madison, WI (US); Somesh Jha, Madison, WI (US); Stefan Katzenbeisser, Eindoven (NL); Johannes Kinder, Muenchen (DE); Helmut Veith, St. Andrae Woerdern (AT)

Correspondence Address: WISCONSIN ALUMNI RESEARCH FOUNDATION, C/O BOYLE FREDRICKSON S.C, 840 North Plankinton Avenue, Milwaukee, WI, 53203, US

(21) Appl. No.: 12/108,406

(22) Filed: Apr. 23, 2008

Related U.S. Application Data
(60) Provisional application No. 60/915,253, filed on May 1, 2007.

(51) Int. Cl. G06F 12/14; G06F 11/30; G06F 9/455

(52) U.S. Cl. 726/24; 711/E12.091; 703/23

(57) ABSTRACT

Computer programs are preprocessed to produce normalized or standard versions to remove obfuscation that might prevent the detection of embedded malware through comparison with standard malware signatures. The normalization process can provide an unpacking of compressed or encrypted malware, a reordering of the malware into a standard form, and the detection and removal of semantically identified nonfunctional code added to disguise the malware.

### CROSS REFERENCE TO RELATED APPLICATION

This application claims the benefit of U.S. provisional application 60/915,253 filed May 1, 2007 hereby incorporated by reference.

This invention was made with United States government support awarded by the following agencies:
NAVY/ONR N00014-01-1-0708
ARMY/SMDC W911NF-05-C-0102

The United States has certain rights in this invention.

### BACKGROUND OF THE INVENTION

The present invention relates to computer programs and, in particular, to a computer program for detecting malicious computer programs (malware) such as computer viruses and the like.

As computers become more interconnected, malicious computer programs have become an increasing problem. Such malicious programs include “viruses”, “worms”, “Trojan horses”, “backdoors”, “spyware”, and the like. Viruses are generally programs attached to other programs or documents to activate themselves within a host computer to self-replicate and attach to other programs or documents for further dissemination. Worms are programs that self-replicate to transmit themselves across a network. Trojan horses are programs that masquerade as useful programs but contain portions to attack the host computer or leak data. Backdoors are programs that open a computer system to external entities by subverting local security measures intended to prevent remote access or control over a network. Spyware are programs that transmit private user data to an external entity. These and similar programs will henceforth be termed “malware”.

A common technique for detecting malware is to scan suspected programs for sequences of instructions or data that match “signature” sequences extracted from known malware types. When a match is found, the user is signaled that a malware program has been detected so that the malware may be disabled or removed.

Many signature detection systems may be defeated by relatively simple code obfuscation techniques that changed the signature of the malware without changing the essential function of the malware code. Such techniques may include changing the static ordering of the instructions by using jump instructions (code transposition), substituting instructions of the signature with different synonym instructions providing the same function (synonym insertion), and the introduction of nonfunctional code (“dead code”) that does not modify the functionality of the malware.

Co-pending U.S. patent application entitled: “Method And Apparatus To Detect Malicious Software”, assigned to the same assignee as the present invention, and hereby incorporated by reference, describes a preprocessor that can reverse some types of malware obfuscation by converting the malware program instructions into a standard form. A search of the de-obfuscated malware for malware signatures is then used to detect malicious code. Such a system employs three processes: a control flow graph (CFG) builder that reorders the instructions according to their control flow, a synonym dictionary that replaces functionally identical sets of instructions with standard equivalents and a dead code remover that removes irrelevant instructions (e.g. “nop” instructions). Irrelevant jump instructions, being unconditional jump instructions that simply jump to the next instruction in the control flow, may also be eliminated.

Malware may be encrypted or compressed (packed), and may execute a decryption or unpacking program once the malware arrives in a host, to unpack or decrypt critical elements of the malware. The encryption or compression serves to hide features of the malware that might be detected by a malware signature detector, until the malware is being executed. A common and normally benign compression program may be used so that signature detection of the unpacking program of decryption program is impractically prone to false positive alerts.

One approach for detecting packed or encrypted programs is to run the signature checker continuously to attempt to find the unpacked program in memory in an unpacked state. This can be impractical for systems where many programs must be monitored.

### SUMMARY OF THE INVENTION

The present invention provides a malware normalizer that may be part of a malware detection system that permits practical detection of encrypted and/or compressed malware programs. The detection of compressed or encrypted malware relies on an insight that a packed or encrypted program can be inferred by detection of a suspect program's execution of data previously written by the suspect program.

The invention also provides for improved de-obfuscation of code reordering and dead code insertion. Improved code reordering is obtained by examining the control flow graph for nodes which have: (1) at least one preceding edge which is an unconditional jump and (2) no “fall-through” edge, as will be defined below. Improved removal of dead code eliminates or supplements a standard “synonym dictionary” with a piecewise analysis of code “hammocks” that produce no net change of external variables.

Specifically then, the present invention may provide a malware normalization program that monitors memory locations written to during execution of a suspect program. Execution by the suspect program of the “written to” memory locations is used to trigger an analysis of the suspect program against malware signatures based on an assumption that any encrypted or compressed code is not decrypted or uncompressed.

Thus it is one feature of at least one embodiment of the invention to provide a reliable and automatic method of signature detection for encrypted or compressed malware.

The signature analysis may be limited to memory locations written to by the suspect program and within a loaded image of the suspect program.

It is another feature of at least one embodiment to simplify the task of signature matching by minimizing the code that must be examined.

The execution of the suspect program may be performed by a computer emulator limiting access by the suspect program to computer resources.

It is another feature of at least one embodiment of the invention to prevent suspect programs from affecting the host computer prior to their analysis.

The monitoring of execution of previously “written to” data may be repeated iteratively.

It is another feature of at least one embodiment of the invention to provide a system that may automatically work with nested levels of packing or encryption.

The invention may include a step of prescreening suspect programs according to an “entropy” of the loaded image suspect program, low entropy generally suggesting compression of a program.

It is therefore a feature of at least one embodiment of the invention to provide a method of reducing the need for full analysis of all suspect programs.

Alternatively or in addition, the invention may include the step of prescreening suspect programs through a static execution of the suspect program detecting an execution of previously “written to” addresses.

It is thus a feature of at least one embodiment of the invention to allow the invention to be used to prescreen programs for possible self-generation.

The invention may further provide a deobfuscation of the decrypted or uncompressed program to correct for instruction reordering before analyzing the program for malware signatures.

It is thus another feature of at least one embodiment of the invention to provide a system that may work with deobfuscation techniques that address code reordering.

The deobfuscation of code reordering may examine the execution order of the instructions and, when a given instruction has no fall-through edge and at least one preceding instruction that is an effective unconditional jump, replace the one effective unconditional jump with the given instruction.

It is thus another feature of at least one embodiment of the invention to provide an improved method of correcting for code reordering obfuscation that may work with complex control flow graphs where multiple branches lead to a single instruction.

The invention may further remove non-functional instructions before checking for malware signatures. In a preferred embodiment, the nonfunctional instructions are identified by finding “hammocks” of instructions within the execution order of the instructions, monitoring data written to during execution of the hammocks; and removing the instructions of the hammock as non-functional instructions when execution of the hammock does not change external data.

It is another feature of at least one embodiment of the invention to provide a method of semantic “dead code” removal that unlike synonym techniques may work with novel obfuscation patterns that may not be in a synonym dictionary.

These particular features and advantages may apply to only some embodiments falling within the claims and thus do not define the scope of the invention.

### BRIEF DESCRIPTION OF THE DRAWINGS

FIG. 1 is a block diagram of a malware normalization/detection system that may employ the present invention;

FIG. 2 is a detailed block diagram of a normalizer of FIG. 1 showing the steps of unpacking/decryption, reordering, and dead code removal;

FIG. 3 is a representation of the loaded image of a suspect program showing its control flow and data flow;

FIG. 4 is a flow chart of the principal steps used in the present invention in the unpacking/decryption block of FIG. 2;

FIG. 5 is a simplified flow chart of a suspect program showing standard instructions and control flow instructions;

FIGS. 6a and 6b are examples of control flow graphs of the program of FIG. 5 showing the steps of code reordering of FIG. 2 per the present invention;

FIG. 7 is a flow chart showing the principal steps used in the present invention in the code-reordering block of FIG. 2 applied to the program of FIG. 6;

FIG. 8 is a control flow graph showing a hammock that may be analyzed per the present invention for dead code removal per FIG. 2; and

FIG. 9 is a flow chart of the principal steps used in the present invention in the dead code removal process block of FIG. 2 applied to the program of FIG. 8.

### DETAILED DESCRIPTION OF THE PREFERRED EMBODIMENT

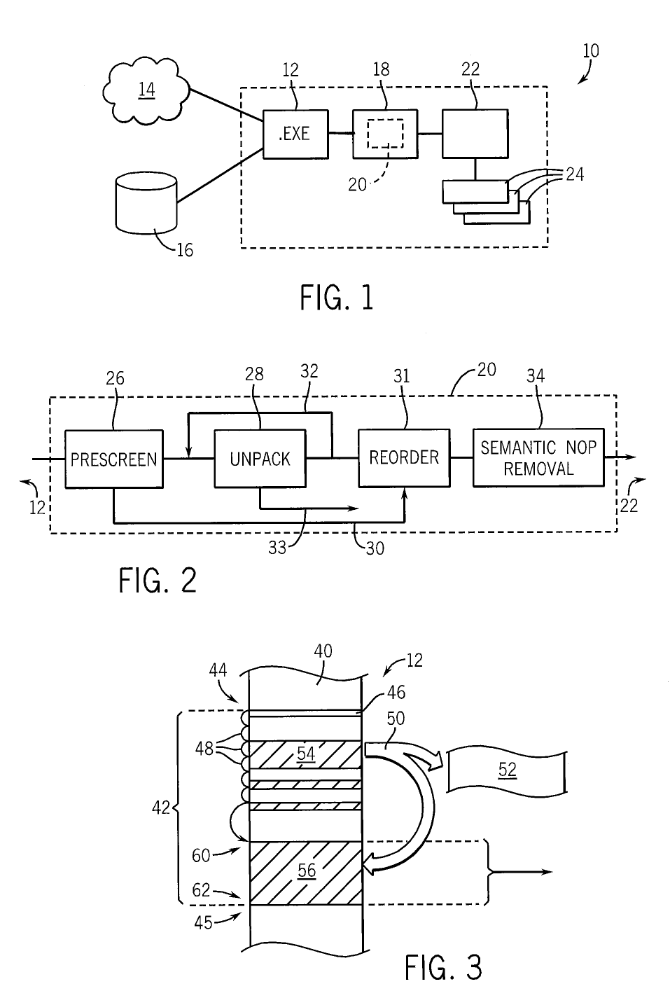

Referring now to FIG. 1, a computer system 10, which may be, for example, a general purpose computer or a network intrusion detection system (an IDS), may receive executable files 12 from a network 14, such as the Internet, or from a storage device 16 such as a hard drive of the computer system 10. The executable files 12 may be programs directly executable under the operating system of the computer system 10 (e.g., “exe” or “bin”) files or may be “scripts” or so-called “application macros” executed by another application program.

The received executable files 12 may be received by a scanner program 18 incorporating a malware normalizer 20 of the present invention which normalizes the code of the executable files 12 and then provides it to a signature detector program 22 that compares the normalized executable files 12 to a set of standard, previously prepared, malware signatures 24.

Referring now to FIG. 2 the malware normalizer 20 of the present invention may provide for a prescreening block 26 which makes an optional predetermination of whether the executable file 12 is likely to be malware or not. This pre-screening is accepting of a significant number of false positives and is intended only to provide improved throughput to the malware normalizer 20 and the signature detector program 22 by eliminating the need to analyze programs that are unlikely to be malicious.

Depending on the determination by the prescreening block 26 the executable file may be passed along to an unpacking program 28 or bypassed, as indicated by bypass path 30, without unpacking to the reordering program 31.

At the unpacking program 28, as will be described further below, executable file 12 is allowed to unpack (decompress) or decrypt itself (if the executable file 12 is packed or encrypted). As used henceforth the terms “pack” and “unpacking” shall be considered to refer also to “encrypt” and “decrypt” and similar functions performed by self-generating code, for example, including optimization, that generally alter the signature of the executable file 12. The unpacking process of unpacking program 28 may be repeated iteratively, as indicated by path 32, so as to unpack executable files 12 that have been packed multiple times. The unpacking program 28 may produce a detection signal 33 when the detection of self-generating code is desired (as opposed to the detection of malware).

At the moment the unpacking or decryption is complete, the unpacked executable file 12 is forwarded to a reordering program 31. If the executable file 12 does not have packing it is passed directly to the reordering program 31 without modification.

The reordering program 31 reorders the instructions of the executable file 12, as received from the unpacking program 28 into a standard form, as will be described, and then passes the reordered executable file 12 to the dead code remover program 34. The dead code remover program 34 removes “semantic nops” being nonfunctional code (not necessarily limited to nop instructions) to provide as an output a normalized executable file 12 that is passed to the signature detector program 22 for comparison to normalized malware signatures 24.

Referring still to FIG. 2, the prescreening block 26 is intended to provide a rough determination of whether the executable file 12 has been packed or encrypted. To the extent that packing programs look for repeating patterns that may be abstracted and expressed more simply (for example long runs of zeros) a compressed program will have a greater entropy or randomness. Thus the prescreening block 26 in one embodiment may compare the entropy of the executable file 12 against a threshold for the determination of likelihood that the executable file 12 is compressed. The threshold is set high enough that nearly all compressed executable files 12 are passed to the unpacking program 28 even at the risk of including some uncompressed executable files 12. Other methods of prescreening can also be employed including those that consider the source of the file or that look for signatures of common unpacking programs and the like.

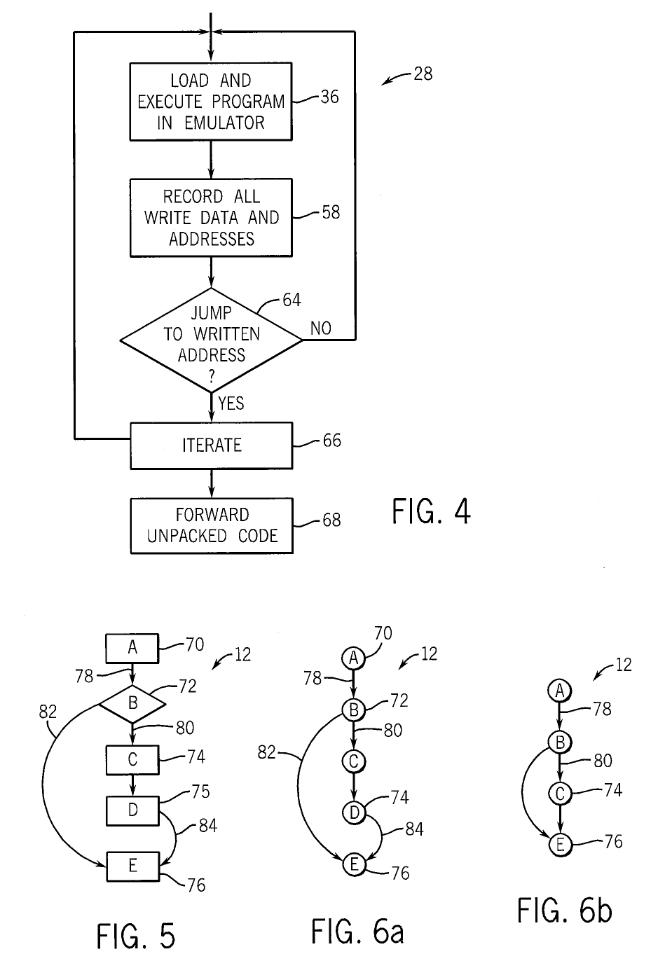

Referring now to FIGS. 2, 3 and 4, the unpacking program 28 receives the executable files 12 suspected of being packed and loads the file into memory 40 to be controllably executed, for example, by an emulator or in a “sandbox” environment as indicated by process block 36. The emulator or sandbox allows the monitoring “reads” and “writes” to memory by the executable file 12 with the ability to block the writing of data outside of the sandbox and the ability to freeze the execution of the executable file during the monitoring process based on memory reads and writes.

As shown in FIG. 3, a loaded image 42 of the executable file 12, including program instructions and data, will be bounded by a logical starting address 44 and an ending address 45 and will begin execution at a start instruction 46 moving throughout the instructions of the executable file 12 as indicated by control flow 48. During execution, data writes 50 may occur both to external data locations 52 for example to “external” memory addresses outside of the loaded image, for example the “heap” or the stack of the computer system 10, or to “internal” memory addresses within the loaded image 42. These internal memory addresses will be tracked per process block 58 of the unpacking program 28 to determine an unpack area 56.

At some point in the execution of the executable file 12, if the executable file 12 is packed, an unpacker program 54 in the executable file 12 will be invoked performing writes 50 to internal memory addresses of code that is being unpacked. These memory addresses are also tracked per process block 58 of the unpacking program 28 to further define the unpack area 56 which will grow, logically bounded by a first instruction 60 and a last instructions 62 although unpack area 56 need not be absolutely continuous within that range.

At decision block 64 of the unpacking program 28, occurring during the execution of each instruction of the executable file 12, the unpacking program 28 checks to see if there has been a jump in the control flow 48 to the unpack area 56 indicating that previously written data is now being executed as instructed. This jump is assumed to signal the conclusion of the unpacking process and the beginning of execution of the malware. At this time, a signal 33 is produced indicating that compression was detected.

At iteration block 66, the unpacking program 28 checks to see if the executable file 12 has concluded execution such as may be detected by movement of the control flow 48 out of the loaded image 42 or by a steady state looping such as may be detected, for example, by analyzing a fixed number of executed instructions. So long as the executable file 12 appears to be continuing execution, the iteration block 64 repeats process blocks 36, 58, and 64 creating a new unpack area 56 within the loaded image and monitoring the control flow 48 for a jump into the new unpack area 56. This process is continued to accommodate possible multiple packing operations.

At the conclusion all the iteration, as indicated by process block 68 of the unpacking program 28, the unpacked code, being for example the unpack area 56 of the final iteration or the union of all unpack areas 56 of all iterations, is sent to the reordering program 31.

Referring now to FIGS. 5, 6a, 6b, and 7, the reordering program 31 builds a control flow graph of the executable file 12 (as possibly unpacked) using for example a disassembler (to recover the source code from the object code of the executable file 12) combined with a control flow graph builder. Disassemblers for this purpose are well known in the art and may, for example, include the IDAPro™ interactive disassembler commercially available from DataRescue of Liege, Belgium (www.datarescue.com). The execution ordered control flow graph may be produced using CodeSurfer™ by GrammaTech, Inc. of Ithaca, N.Y. (www.grammatech.com).

Referring specifically to FIG. 5, an executable file 12 received from the unpacking program 28 may, for example, include an instruction 70 (A) followed by a conditional branch instruction 72 (B) followed by an arbitrary instruction 74 (C) followed by an unconditional jump instruction 75 (D) and an arbitrary instruction 76 (E). Instruction 72 and 75 are a control flow instructions, that is, they direct the control flow of the executable file 12, while the remaining instructions are non-control flow instructions.

As shown in FIG. 6a each of these instructions 70-76 may represent a node in a control flow graph with control flow paths between them representing edges in a control flow graph. The edge 78 connecting instructions 70 and 72 will be termed a “fall-through edge” being any edge linking a non-control flow instruction with its unique control flow successor. The edge 80 connecting instructions 72 and 74 will also be termed a “fall-through edge” because it represents the false path of the conditional control flow instruction.

The edge 82 connecting instructions 72 and 76 is a conditional jump instruction and the edge 84 connecting instructions 72 and 76 is an unconditional jump instruction.

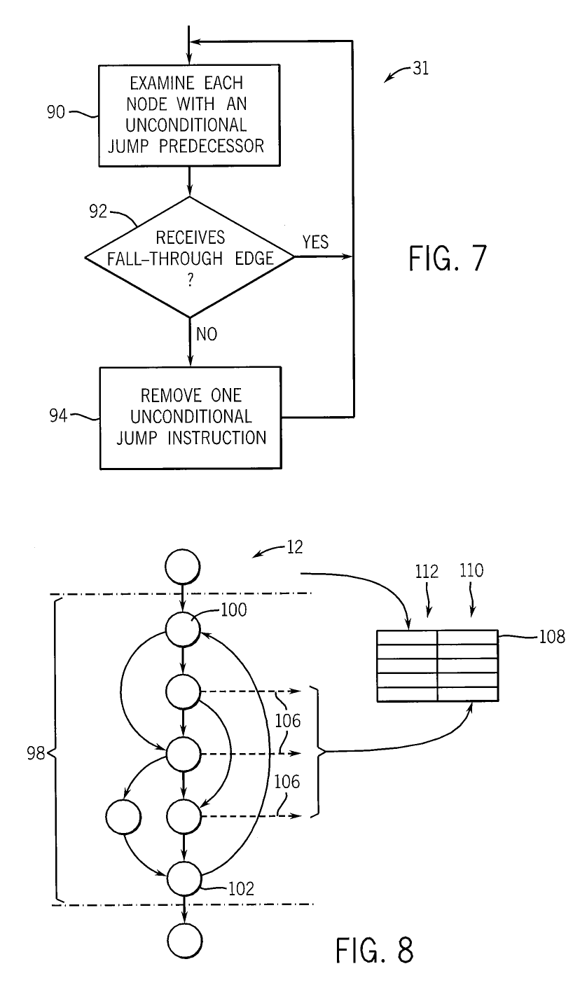

Per FIG. 7, and as shown by process block 90, the reordering program 31 of FIG. 2 tests each node of the control flow graph of FIG. 6a to see that each node with at least one unconditional jump edge also has exactly one fall-through edge per decision block 92. In this example, node 76 receives an unconditional jump edge 84 and when the test is applied to node 76 it is apparent that node 76 does not have a fall-through edge.

In this case, and as shown by process block 94, the executable file 12 is edited by the reordering program 31 to remove the unconditional jump instruction 75 and replace it with its target 76 as shown in FIG. 6b.

When there is more than one unconditional jump predecessor for a given node (and that node has no fall-through edges) an arbitrary unconditional jump instruction may be eliminated. In a preferred embodiment, the unconditional jump instruction that is eliminated is the last unconditional jump predecessor in the order of the control flow graph. In a more sophisticated embodiment, conditional jump instructions that always jump are detected and treated as unconditional jump instructions.

Referring now to FIGS. 2, 8 and 9, after code reordering per the reordering program 31, the program is received by a dead code remover program 34. Unlike conventional dead code removal tools that collect lists of non-functional code, for example, strings all of nop instructions, or successive incrementing and decrementing of a variable, and their functional synonyms in a predefined table, the present invention employs a semantic analysis approach that may detect nonfunctional code that has not previously been observed and catalogued.

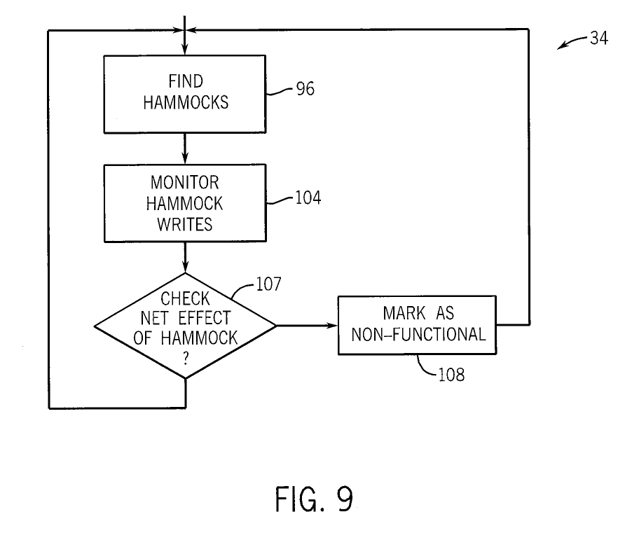

Referring to FIG. 9, at a first step of this process indicated by process block 96, the dead code remover program 34 searches for “hammocks” in the executable files 12. Hammocks are sections of the control flow graph having a single entry node and a single exit node, that is, there are no nodes between the entry and exit node that are connected by edges to nodes outside the hammock. For example, as shown in FIG. 8, hammock 98 may be identified by its single entry node 100 and single exit node 102.

Generally hammocks will occur with structured “if”, “while”, and “repeat” statements but may also occur in other contexts.

Per process block 104 of the dead code remover program 34, the execution of the instructions within the hammock 98 (for example using the emulator or sandbox described above) is monitored keeping track of each write 106 performed by an instruction in the hammock 98, for example, by enrolling those written values and their addresses in a buffer table 108 to be refreshed at each hammock 98. If a given address receives a multiple write, the last written value is the one held in the table 108. The table 108 also preserves the original values 112 for each of the written values 110.

This population of the table 108 may also be performed by a static analysis of the instructions of the hammock 98.

At the conclusion of the execution of the hammock 98, that is when the hammock 98 is exited from at node 102, per process block 107, the original values 112 and written values 110 are compared. If they are identical, then the hammock represents nonfunctional or dead code insofar as there has been no net change in any variable.

Referring again to FIG. 2 upon completion of the operation of the dead code remover program 34, the resulting processed and normalized executable file 12 is forwarded to the signature detector program 22 as seen in FIG. 1. In this case it is important that the signatures 24 also be of normalized malware executable files.

It is specifically intended that the present invention not be limited to the embodiments and illustrations contained herein, but include modified forms of those embodiments including portions of the embodiments and combinations of elements of different embodiments as come within the scope of the following claims.

What we claim is:

1. A malware normalization program executable on an electronic computer to:
(1) monitor writing to memory by a suspect program during execution of a suspect program;
(2) detect an execution of instruction by the suspect program of data of memory locations previously written to by the suspect program; and
(3) based upon the detection, output the data of memory locations previously written to by the suspect program for malware signature analysis.

2. The malware detection program of claim 1 wherein the step of analyzing only analyzes memory locations written to by the suspect program only within a loaded image of the suspect program.

3. The malware detection program of claim 1 wherein the execution is performed by a computer emulator limiting access by the suspect program to computer resources.

4. The malware detection program of claim 1 further iterating steps (1)-(3) with the memory locations previously written to by the suspect program standing as a new suspect program.

5. The malware detection program of claim 1 including the step of prescreening suspect programs according to an entropy of data of the suspect program.

6. The malware detection program of claim 1 further including a deobfuscation of instructions of the memory locations written to by the suspect program to correct instruction reordering before providing the instructions of the memory locations for malware signature analysis.

7. The malware detection program of claim 6 wherein the instruction reordering examines the execution order of the instruction, and when a given instruction has no fall-through edge and at least one preceding instruction providing an effective unconditional jump, replacing the preceding instruction with the instruction;
wherein an effective unconditional jump includes unconditional jumps and conditional jumps that always jump because of their predicate; and
wherein a fall-through edge is a control flow between the instruction and a preceding non-control flow instruction or a false path of a conditional control flow instruction.

8. The malware detection program of claim 1 further including a deobfuscation of the memory locations written to by the suspect program to remove non-functional instructions before checking for malware signatures.

9. The malware detection program of claim 8 wherein the non-functional instructions are identified by:
(1) finding hammocks of instructions within the execution order of the instructions, the hammocks having a single entry and single exit instruction in a control flow of the instructions;
(2) monitoring data written to during execution of the hammocks; and
(3) identifying the instructions of a hammock as non-functional instructions when data written to is not changed at a conclusion of the hammock from its state just before execution of the hammock.

10. A method of detecting malware on an electronic computer comprising:
(1) monitoring a writing to memory by a suspect program during execution of the suspect program;
(2) detecting an execution of instruction by the suspect program at memory locations previously written to by the suspect program; and
(3) providing the instructions of the memory locations written to by the suspect program for malware signature analysis.

11. The method of claim 10 wherein the step of analyzing only analyzes memory locations written to by the suspect program only within a loaded image of the suspect program.

12. The method of claim 10 wherein the execution is performed by a computer emulator limiting access by the suspect program to computer resources.

13. The method of claim 10 further including the step of iterating steps (1)-(3) with the memory locations previously written to by the suspect program standing as a new suspect program.

14. The method of claim 10 including the step of prescreening suspect programs according to an entropy of data of the suspect program.

15. The method of claim 10 further including a deobfuscation of instructions of the memory locations written to by the suspect program to correct instruction reordering before providing the instructions of the memory locations for malware signature analysis.

16. The method of claim 15 wherein the instruction reordering examines the execution order of the instruction and when a given instruction has no fall-through edge and at least one preceding instruction providing an effective unconditional jump, replacing the preceding instruction with the instruction;
wherein an effective unconditional jump includes unconditional jumps and conditional jumps that always jump because of their predicate; and
wherein a fall-through edge is a control flow between the instruction and a preceding non-control flow instruction or a false path of a conditional control-flow instruction.

17. The method of claim 10 further including a deobfuscation of the memory locations written to by the suspect program to remove non-functional instructions before checking for malware signatures.

18. The method of claim 17 wherein the non-functional instructions are identified by:
(1) finding hammocks of instructions within the execution order of the instructions, the hammocks having a single entry and single exit instruction in a control flow of the instructions;
(2) monitoring data written to during execution of the hammocks; and
(3) identifying the instructions of a hammock as non-functional instructions when data written to is not changed at a conclusion of the hammock from its state just before execution of the hammock.

19. A malware normalization program executable on an electronic computer to:
(1) analyze instructions of a suspect program to find hammocks of instructions within an execution order of the instructions, the hammocks having a single entry and single exit instruction in a control flow of the instructions;
(2) monitoring data written by instructions of the hammock during execution of the hammock;
(3) identifying the instructions of a hammock as non-functional instructions when data written to is not changed at the conclusion of the hammock from its state just before execution of the hammock;
(4) providing the instructions of the suspect program without the non-functional instructions for malware signature analysis.

20. A computer program for normalizing instruction execution order, the program executable on an electronic computer to:
(1) review an execution order of instructions of a target computer program; and
(2) when a given instruction has no fall-through edge and at least one effective unconditional jump, replacing one effective unconditional jump with the given instruction;
wherein an effective unconditional jump includes unconditional jumps and conditional jumps that always jump because of their predicate; and
wherein a fall-through edge is a control flow between the instruction and a preceding non-control flow instruction of a false path of a conditional control-flow instruction.
